(19) United States
(12) Patent Application Publication
(10) Pub. No.: US 2003/0183982 A1
(43) Pub. Date: Oct. 2, 2003

(54) Method for producing thin membrance-type structure components

(76) Inventors: Josef Jansen, Koln (DE); Rudolf F.J. Meess, Aachen (DE); Sebastian Willeke, Aachen (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/363,194

(22) PCT Filed: Oct. 2, 2001
(86) PCT No.: PCT/DE01/03811

(30) Foreign Application Priority Data
Oct. 9, 2000 (DE) 100 50 305.5

(51) Int. Cl. B29C 41/20

(52) U.S. Cl. 264/259; 264/308

(57) ABSTRACT

The invention relates to a method for producing thin membrane-type structural components, especially flaps for cardiac valves, or for producing a multilayer membrane or a thin surface coating on the basis of a polymer, wherein the individual layers are produced on a base body while forming a solid link with said base body or the membrane-type structural components are applied to a support tool and the membrane-type structural components are then detached (separated) therefrom. The aim of the invention is to achieve a defined thickness distribution of the thin membranes or films. To this end, individual droplets of a polymer solution or droplets from viscous polymerizing multicomponent systems are applied to the base or the support tool in a punctiform manner, linearly in one row, in a caterpillar shape or across the surface of the based body or the support tool. The applied solution is then dried and application of the droplets and drying is repeated until the desired shape of a three-dimensional polymer body is obtained.

The invention relates to a method of producing thin membrane-like structural components, in particular cusps for cardiac valves, or membranes comprised of several layers or a surface coating from a polymer, whereby individual layers are created on a base, tightly bonded thereto, or the membrane-like structural components are built up on a support tool from which the membrane-like structural components are subsequently stripped (separated).

The method according to the invention is in particular usable in the production of flexible cardiac-valve prostheses with defined and reproducible thicknesses produced in the individual parts.

EP 0,114,025 describes a cardiac-valve cusp produced by dipping an appropriately shaped male mold one or more times in a polyurethane solution. The cusps, which are stripped from the male mold after separation, have to be fixed to a support, for example by gluing. The gluing inherently produces at the joint between the valve cusps and the valve support adhesive adhesions and irregularities that can lead to deposition of cellular blood particles and calcification. As an alternative to such a procedure, EP 0,114,025 describes how the valve cusps are first formed by immersion of a two-part male mold body and then, after insertion into a female mold part, a sort of valve support is formed also by dipping so that in this step the joints between the valve cusps and the valve support are formed. This method is however relatively expensive because it requires the use of very accurately made molds or thickness variations are created that lead to irregular loading.

In order to avoid these disadvantages EP 0,114,025 proposes dipping a male mold (of stainless steel or plastic)) having surfaces corresponding to the cusps to be formed in a first polymer solution with a viscosity in the neighborhood of 24-192 PA.s at such a slow speed as to prevent bubbles or the like from being created and creating irregularities on the polymer forming on the male mold. After complete immersion the male mold covered with a film is lifted out of the solution and dried. This process can be repeated until the desired thickness is achieved. Then a preformed valve support is supported in a second polymer solution of lower viscosity in the neighborhood of 1.5-2 Pa.s such that the solution can flow out of lower outlets from inside the valve support. The male mold coated with the cusps is dipped in this second polymer solution and fitted to the valve ring submerged in it. After a short residence time in the solution the male mold with the valve support is raised out of the solution and dried. Thereafter the complete cardiac valve is stripped off the male mold. The thus produced cardiac valve thus is comprised of a support on which several cusps are secured. Such a heart valve, which can also be provided with a suture ring, is intended for installation in a human. Basically and as for example described in WO 97/49,356 such structures are also usable in tubular cardiac-valve implants although this the references do not say how this should be done for tubular cardiac-valve prostheses.

It is an object of the present invention to provide a method of applying defined doses of polymer solution or viscose polymerizing multicomponent systems to a mole or an already made surface that is produced by a dipping or injection-molding system.

This object is attained by the method defined in claim 1 according to which individual droplets or a continuous stream of a polymer solution or droplets or a continuous stream of a viscose polymerizing multicomponent system are applied in points, in lines, in strips, in beads, or as a layer to the base body or a support tool, the layer is dried, and the application of droplets or of the stream and the subsequent drying is repeated until the desired three-dimensionally shaped polymer body is formed.

The distinguishing feature over the known method in plastic production is that a defined distribution of thickness of the thin membranes or foils can be set and reproduced. The basic idea of the invention is that the surface of a substrate of any shape, as for example the surfaces of a tool, can be coated with individual droplets of a liquid polymer, preferably a polymer that contains an organic solvent. In order to apply the droplets a dosing tool is used that is moved along an exact positioning path spaced from the tool and droplets are fired at particular predetermined points on the workpiece. The droplets can be laid down adjacent one another so that they come to touch and eventually form a continuous (if necessary liquid) polymer film. In this manner a few or many layers can be built up successively to a defined thickness distribution or the desired foil. According to the present invention it is also possible to lay down the individual droplets on the tool that they are adjacent and do not touch. After drying of the individual droplets, further droplets are deposited in still uncoated spaces so that in this manner several regions are coated in a pattern that imparts to the desired film the desired thicknesses. Preferably the individual droplets are applied in a process comparable to spitting. Alternatively spraying is possible, the stream pumped by the dosing system being comprised of reproducible individual droplets or a defined mass. At the same time it is possible according to the present invention to apply the droplets individually to the substrate to be coated from a dozing nozzle controlled relative to an axis.

According to a further feature of the invention the method of the invention can be used to apply different polymer solutions that produce a sandwich-like formation. This formation is such that for example a cardiac-valve cusp has a relatively hard and/or unbendable core layer that is surrounded by softer bendable materials. If necessary the free cardiac-valve cusp edges that engage one another on closing, are formed as thickened seal lips. Preferable elasticity modules for such valve-cusp surface layers are in the range of 4 N/mm² to 40 N/mm² while the core material has an elasticity modulus from 40 N/mm² to 200 N/mm². Similarly a cardiac-valve support carrying a cusp can have a relatively hard core whose elasticity modulus is in the range of 200 N/mm² to 1000 N/mm². This core is covered by one or more layers of a softer polymer material.

The process according to the invention can of course be combined with the already described manufacturing process using dipping or injection, whereby in these situations the dosing method for smoothing the surfaces of the cusps by appropriately focused application of individual droplets and/or for adhering the cusps to a premade support that in turn if necessary is provided with a smooth surface of a desired biocompatible polymer. The surface coating or the bonding layer for the surface coating can if necessary include additives like fibers, preferably with a predetermined orientation, or even fillers.

Advantageously the method is used to make an artificial cardiac valve comprised of a support and cusps fixed to it, whereby a support mold with forward surfaces that have the shapes of the cusps is first coated by successive application of droplets alternating with drying, and subsequently in the same manner at least parts or layers of the support are formed.

According to a further embodiment of the invention after forming a part of the support, a metal ring, preferably of titanium or a titanium alloy, is slipped over the formed support-ring part and subsequently the metal ring and the support-ring part of the support are thickened to the desired dimensions by enveloping or coating.

Preferably during layer formation the individual droplets or the continuous stream (before application) have a diameter of 0.2 mm to 1 mm, preferably 0.15 mm to 1 mm and/or have a volume from 42 nl to 4.2 μl, preferably 34 nl to 13 μl. Preferably the surface diameter of the applied droplets of or the continuous stream is 0.25 mm to 2.5 mm. It is advantaged when the viscosity of the polymer solution serving for coating is 1 mPas to 50 Pas. The polymer solution is polyurethane in DMAC, preferably in a concentration of 1% to 15%.

The coating process according to the present invention is conducted at a temperature between 15° C. and 60° C., preferably up to 40° C. and/or in a nitrogen atmosphere.

According to the invention the dip process of the prior art can be combined with the object of this invention using dosing in that for example a first thin layer is produced by dipping a tool in a polymer solution and subsequently drying it. The thus produced layer is thickened with further layers by successive application of droplets, and then the added layers are covered by a final layer produced by dipping. If necessary these steps can be repeated until the body has the desired thicknesses. In particular the droplet-wise layering according to the invention can produce specific thicknesses in specific regions, for example providing a cusp with thickened seal lips at its edges.

While it is indeed possible according to the prior-art dipping method to change the bath in which the body is dipped and thus to produce a multilayer foil of (different) polymers, the droplet-wise or strip-wise application by a dosing nozzle moved in successive controlled passes has the advantage that locally desired thickness variations can be produced. In addition with the method of this invention any region can be provided with a layer while for example with the known dipping method the workpiece is always uniformly coated so that it is impossible to apply a layer in the middle of a field. The method according to the invention can be used to join individual structural elements since the joint zone is given the desired shape. This is significant in particular in the production of cardiac-valve prostheses to produce a physiologically optimal shape.

The method of the invention is in addition able to produce a local effect on the properties of the structural element. Thus in particular the application of polymer beads in parallel lines to a foil of soft polymer produces a direction-controlled flexing. At the same time preset dimensional characteristics can be set by the application of three-dimensional shapes of different materials.

1. A method of producing thin membrane-like structural components, in particular cusps for cardiac valves, or membranes comprised of several layers. or a surface coating from a polymer, whereby individual layers are created on a base, tightly bonded thereto, or the membrane-like structural components are built up on a support tool from which the membrane-like structural components are subsequently stripped (separated),
characterized in that
individual droplets or a continuous stream of a polymer solution or droplets or a continuous stream of a viscose polymerizing multicomponent system are applied in points, in lines, in strips, in beads, or as a layer to the base body or a support tool, the layer is dried, and the application of droplets or of the stream and the subsequent drying is repeated until the desired three-dimensionally shaped polymer body is formed.

2. The method according to claim 1, characterized in that the individual droplets are applied next to one another at a spacing such that they form a continuous polymer film.

3. The method according to claim 1 or 2, characterized in that when making multilayer polymer films, different polymer solutions are used in order to produce a sandwich-like polymer film.

4. The method according to one of claims 1 to 3, characterized in that the surface coating is applied to a base made by injection molding or a dip process.

5. The method according to one of claims 1 to 4, characterized in that the coating is used to bond two parts together or for surface smoothing.

6. The method according to one of claims 1 to 5, characterized in that the surface coating contains additives such as fibers, preferably with a specific orientation, or fillers.

7. A method of making an artificial cardiac valve comprised of a support and cusps fixed to it according to one of claims 1 to 6, characterized in that a support mold with forward surfaces that have the shapes of the cusps is first coated by successive application of droplets alternating with drying, and subsequently in the same manner at least parts or layers of the support are formed.

8. The method according to claim 7, characterized in that after forming a part of the support, a metal ring, preferably of titanium or a titanium alloy, is slipped over the formed support-ring part and subsequently the metal ring and the support-ring part of the support are thickened to the desired dimensions by enveloping or coating.

9. The method according to one of claims 1 to 8, characterized in that the individual droplets or the continuous stream (before application) have a diameter of 0.2 mm to 1 mm, preferably 0.15 mm to 1 mm and/or have a volume from 42 nl to 4.2 μl, preferably 34 nl to 13 μl.

10. The method according to one of claims 1 to 9, characterized in that the surface diameter of the applied droplets of or the continuous stream is 0.25 mm to 2.5 mm.

11. The method according to one of claims 1 to 10, characterized in that the viscosity of the polymer solution serving for coating is 1 mPas to 50 Pas.

12. The method according to one of claims 1 to 11, characterized in that the used solution is polyurethane in DMAC, preferably in a concentration of 1% to 15%.

13. The method according to one of claims 1 to 12, characterized in that the polymer solution is applied in droplets at a temperature between 15° C. and 60° C., preferably up to 40° C. and/or in a nitrogen atmosphere.
